(19) United States
(12) Patent Application Publication
(10) Pub. No.: US 2013/0321749 A1
(43) Pub. Date: Dec. 5, 2013

(54) Liquid Crystal Display Device

(71) Applicant: Xinhui Zhong, Shenzhen City (CN)

(72) Inventor: Xinhui Zhong, Shenzhen City (CN)

(73) Assignee: Shenzhen China Star Optoelectronics Technology Co., LTD., Shenzhen City (CN)

(21) Appl. No.: 13/577,250

(22) PCT Filed: Jun. 8, 2012
(86) PCT No.: PCT/CN12/76616

§ 371 Date: Aug. 5, 2012

(30) Foreign Application Priority Data
Jun. 1, 2012 (CN) 201210177939.6

(51) Int. Cl. G02F 1/1335

(52) U.S. Cl. 349/106

(57) ABSTRACT

The present invention provides a liquid crystal display device, which includes a TFT substrate, a CF substrate bonded to the TFT substrate, photo spacers arranged between the TFT substrate and the CF substrate, an enclosing resin frame arranged between the TFT substrate and the CF substrate, and liquid crystal received in the enclosing resin frame. Each of the photo spacers has two opposite ends, which are respectively in contact with the CF substrate and the TFT substrate. The contact area between the two opposite ends of a photo spacer that is located at a central position of the CF substrate and the TFT substrate and the CF substrate and the TFT substrate is smaller than the contact area between the two opposite ends of a photo spacer that is located at a marginal position of the CF substrate and the TFT substrate and the CF substrate and the TFT substrate.

### BACKGROUND OF THE INVENTION

1. Field of the Invention

The present invention relates to the field of liquid crystal displaying, and in particular to a liquid crystal display device.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal display panel and a backlight module. The working principle of the liquid crystal display panel is that liquid crystal polymer molecules interposed between two parallel glass substrates and a plurality of vertical and horizontal fine electrical wires is arranged between the two glass substrates, whereby the liquid crystal molecules are controlled to change direction by application of electricity in order to refract light emitting from the backlight module for generating images.

As shown in FIG. 1, a liquid crystal display device is generally composed of an upper structure 100 of color filter (CF), a low substrate 200 of thin film transistor (TFT), and liquid crystal (LC) 300, photo spacers (PS) and sealant 500 interposed between the upper substrate 100 and the lower substrate 200. A general manufacturing process comprises a front stage of array process (including thin film, yellow light, etching, and film stripping), an intermediate stage of cell process (including bonding TFT substrate and the CF substrate), and a rear stage of assembling process (including mounting drive ICs and printed circuit board). The front stage of array process generally makes the TFT substrate for controlling the movement of liquid crystal molecules. The intermediate stage of cell process generally introduces the liquid crystal between the TFT substrate and the CF substrate. The rear stage of assembling process generally mounts the drive ICs and combining the printed circuit board to effect driving the liquid crystal molecules to rotate for displaying images.

The photo spacers are provided for bearing the force acting on the panel and support and maintain the distance between the upper and lower substrates. However, if the contact area between the photo spacers and the substrates is excessively large, when shifting occurs between the upper and lower sides, the photo spacers are acted upon by an excessively large frictional force from the substrates, making it difficult to resume the original properties. Further, deformation caused by friction may cause change of orientation of the surrounding liquid crystal, leading to leakage of light. On the other hand, if the contact area between the photo spacers and the substrates is excessively small, then it would be difficult for the substrates, after being compressed, to resume the original height.

With the increasingly enlarged size of panel, the circumference of the panel may be subjected to increased forces during manufacture and shipping and the interior of the panel has to take great bending deformation and shifting friction. Such a problem is not properly handled in the conventional liquid crystal panels.

### SUMMARY OF THE INVENTION

An object of the present invention is to provide a liquid crystal display device, which provides a central zone and a circumferential zone of a TFT substrate and a CF substrate with different bearing capabilities and deformation restoring capabilities by changing contact areas between photo spacers and the TFT substrate and the CF substrate, whereby the TFT substrate and the CF substrate may take greater forces without causing light leakage phenomenon and the structure is simple and the cost is low.

To achieve the object, the present invention provides a liquid crystal display device, which comprises a liquid crystal display device, which comprises: a TFT substrate, a CF substrate bonded to the TFT substrate in an opposing manner, a plurality of photo spacers arranged between the TFT substrate and the CF substrate, an enclosing resin frame arranged between the TFT substrate and the CF substrate, and liquid crystal received in the enclosing resin frame, wherein each of the photo spacers has two opposite ends, which are respectively in contact with the CF substrate and the TFT substrate. The contact area between the two opposite ends of a photo spacer that is located at a central position of the CF substrate and the TFT substrate and the CF substrate and the TFT substrate is smaller than the contact area between the two opposite ends of a photo spacer that is located at a marginal position of the CF substrate and the TFT substrate and the CF substrate and the TFT substrate.

The contact area between the two opposite ends of each of the photo spacers and the CF substrate and the TFT substrate is increased from the central position of the CF substrate and the TFT substrate toward the marginal position of the CF substrate and the TFT substrate.

The contact area between the two opposite ends of each of the photo spacers and the CF substrate and the TFT substrate is increased, in a linear form, from the central position of the CF substrate and the TFT substrate toward the marginal position of the CF substrate and the TFT substrate.

The contact area between the two opposite ends of each of the photo spacers and the CF substrate and the TFT substrate is increased, in a parabolic form, from the central position of the CF substrate and the TFT substrate toward the marginal position of the CF substrate and the TFT substrate.

The parabolic increase has an increase rate that starts with a high speed and then slows down.

The parabolic increase has an increase rate that starts with a low speed and then speeds up.

The variation of the contact area between the two opposite ends of the photo spacer and the CF substrate and the TFT substrate is realized by varying end surface areas of the two opposite ends of the photo spacer. The end surface areas of the photo spacer are varied by increasing from the central position of the CF substrate and the TFT substrate toward the marginal position of the CF substrate and the TFT substrate.

The photo spacers are uniformly distributed between the TFT substrate and the CF substrate.

The photo spacers are spheres, cylinders, elliptic cylinders, or prisms.

The prisms are triangular prisms, quadrangular prisms, or hexagonal prisms.

The photo spacers are at least two of spheres, cylinders, elliptic cylinders, and prisms.

The efficacy of the present invention is that the present invention provides a liquid crystal display device, which provides the central zone and the marginal zone of the TFT substrate and the CF substrate with different bearing capabilities and deformation restoring capabilities by varying the contact areas between the photo spacers and the TFT substrate and the CF substrate. The contact areas within the marginal zone are greater and show greater bearing capabilities to support the box thickness. The contact areas within the central zone are smaller and show better deformation restoring capabilities in order to prevent the photo spacers from deformation caused by excessive frictional force, which leads to the occurrence of light leakage phenomenon. The structure is simple and the cost is low.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a schematic view showing a conventional liquid crystal display device;

FIG. 2 is a schematic view showing an embodiment of liquid crystal display device according to the present invention;

FIG. 3 is a plot showing a relationship between contact area between photo spacers and TFT substrate and CF substrate of the liquid crystal display device according to the present invention and positions of the photo spacers with respect to the TFT substrate and the CF substrate, which a linear increasing curve;

FIG. 4 is a plot showing another relationship between contact area between photo spacers and TFT substrate and CF substrate of the liquid crystal display device according to the present invention and positions of the photo spacers with respect to the TFT substrate and the CF substrate, which a parabolic increasing curve;

FIG. 5 is a plot showing a further relationship between contact area between photo spacers and TFT substrate and CF substrate of the liquid crystal display device according to the present invention and positions of the photo spacers with respect to the TFT substrate and the CF substrate, which a parabolic increasing curve;

FIG. 6 is a schematic view showing shapes and distribution of photo spacers of an embodiment of liquid crystal display device according to the present invention; and

FIG. 7 is a schematic view showing shapes and distribution of photo spacers of another embodiment of liquid crystal display device according to the present invention.

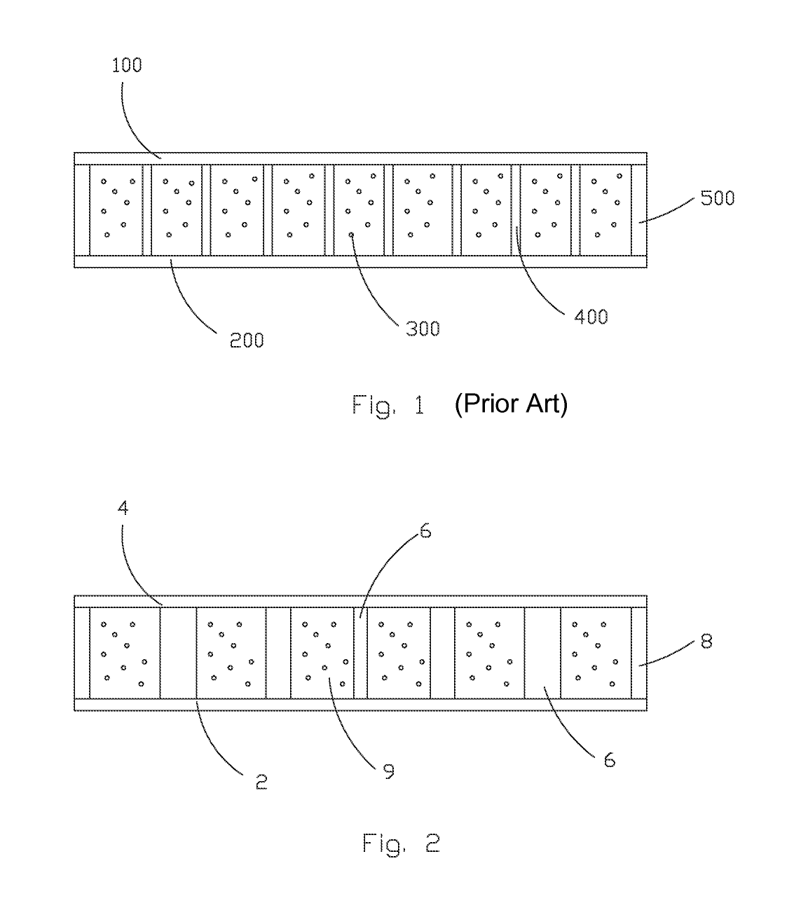

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

Referring to FIG. 2, the present invention provides a liquid crystal display device, which comprises: a TFT substrate 2, a CF substrate 4 bonded to the TFT substrate 2 in an opposing manner, a plurality of photo spacers 6 arranged between the TFT substrate 2 and the CF substrate 4, an enclosing resin frame 8 arranged between the TFT substrate 2 and the CF substrate 4, and liquid crystal 9 received in the enclosing resin frame 8. Each of the photo spacers 6 has two opposite ends, which are respectively in contact with the CF substrate 4 and the TFT substrate 2. The contact area between the two opposite ends of the photo spacer 6 that is located at a central position of the CF substrate 4 and the TFT substrate 2 and the CF substrate 4 and the TFT substrate 2 is smaller than the contact area between the two opposite ends of a photo spacer 6 that is located at a marginal position of the CF substrate 4 and the TFT substrate 2 and the CF substrate 4 and the TFT substrate 2, whereby a central zone and a marginal zone of the TFT substrate 2 and the CF substrate 4 are provided with different bearing capabilities in such a way that the marginal zone has a relatively great bearing capability for supporting box thickness and the contact area in the central zone is relatively small to prevent the photo spacers 6 from deformation caused by excessively large frictional force, which leads to the occurrence of light leakage phenomenon. The structure is simple and the cost is low.

The photo spacers 6 are uniformly distributed between the TFT substrate 2 and the CF substrate 4. In the instant embodiment, the photo spacers 6 are located inwardly of the enclosing resin frame 8. The photo spacers 6 can be spheres, cylinders, or prisms, or at least two of spheres, cylinders, and prisms. The prisms can be triangular prisms, quadrangular prisms, or hexagonal prisms.

The contact area between the two opposite ends of each of the photo spacers 6 and the CF substrate 4 and the TFT substrate 2 is increased from the central position of the CF substrate 4 and the TFT substrate 2 toward the marginal position of the CF substrate 4 and the TFT substrate 2.

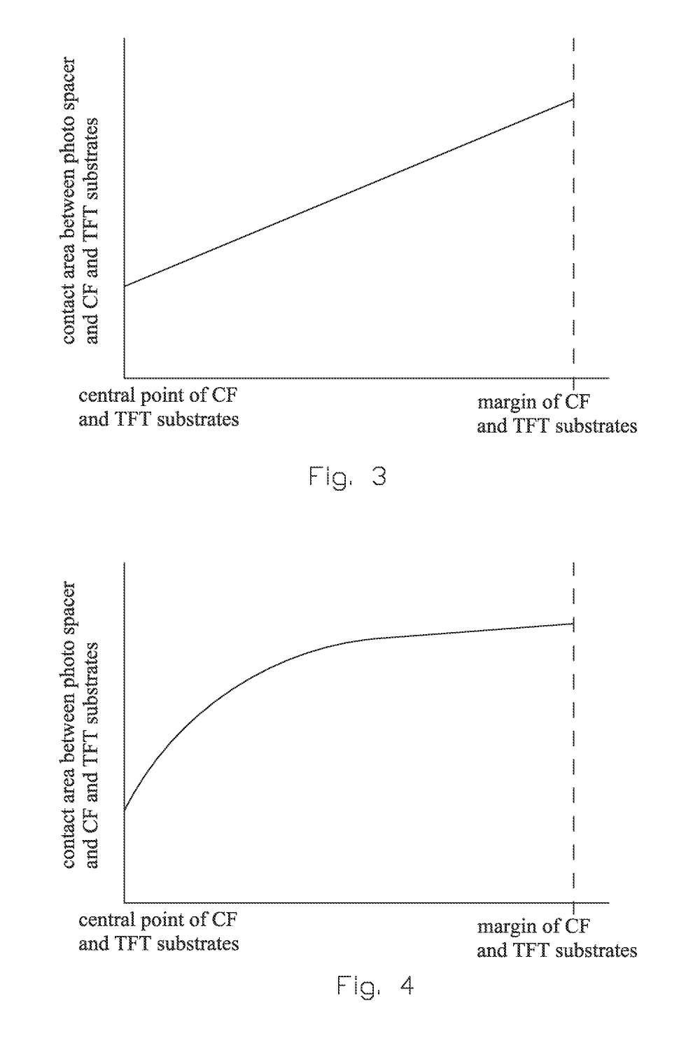

The contact area between the two opposite ends of each of the photo spacers 6 and the CF substrate 4 and the TFT substrate 2 is increased, in a linear form, from the central position of the CF substrate 4 and the TFT substrate 2 toward the marginal position of the CF substrate 4 and the TFT substrate 2 (see FIG. 3). Alternatively, the contact area between the two opposite ends of each of the photo spacers 6 and the CF substrate 4 and the TFT substrate 2 is increased, in a parabolic form, from the central position of the CF substrate 4 and the TFT substrate 2 toward the marginal position of the CF substrate 4 and the TFT substrate 2, wherein the increase rate of the parabolic increase can start with a high speed and then slow down (as shown in FIG. 4) or start with a low speed and then speed up (as shown in FIG. 5).

The variation of the contact area between the two opposite ends of the photo spacer 6 and the CF substrate 4 and the TFT substrate 2 is realized by varying the end surface areas of the two opposite ends of the photo spacer 6. The end surface areas of the photo spacer 6 are varied by increasing from the central position of the CF substrate 4 and the TFT substrate 2 toward the marginal position of the CF substrate 4 and the TFT substrate 2.

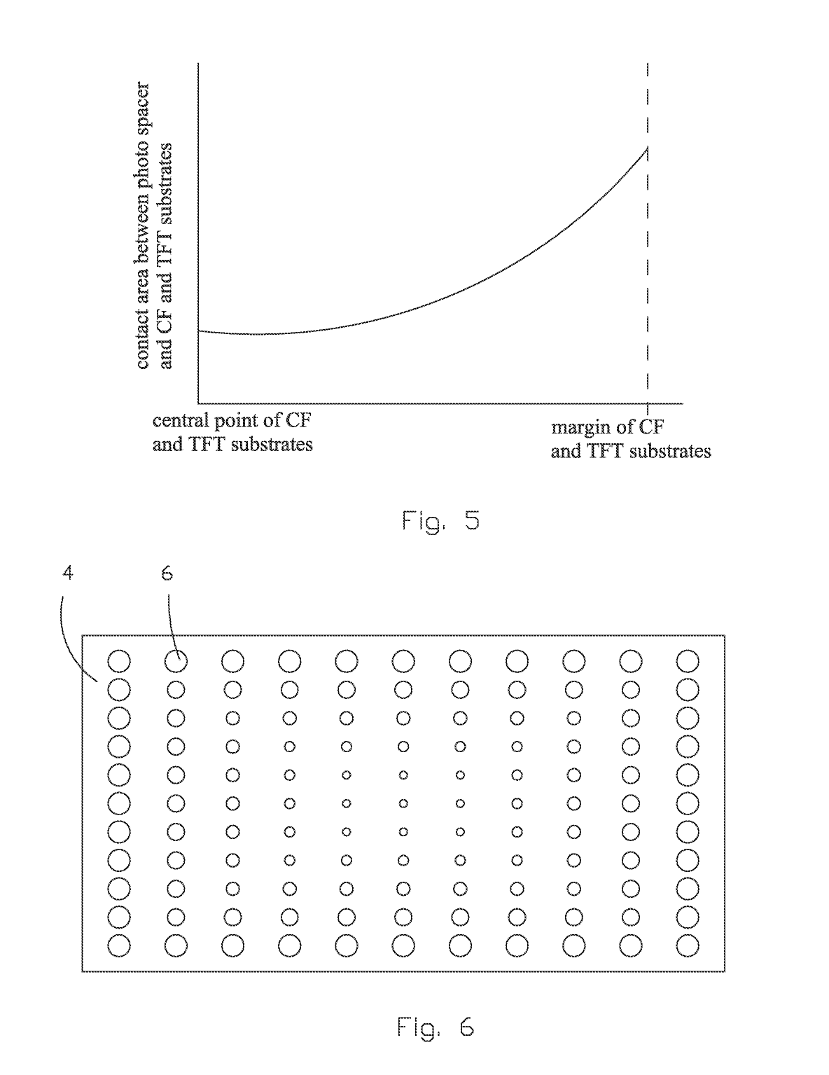

Referring to FIGS. 2 and 6, FIG. 6 is a schematic view showing shapes and distribution of the photo spacers 6 of an embodiment of liquid crystal display device according to the present invention with the photo spacers 6 being shown in contact with the CF substrate 4 to serve as an example for explanation. In the instant embodiment, the plurality of photo spacers 6 has identical shapes, which are cylinders. The contact area between the two opposite ends of each of the photo spacers 6 and the CF substrate 4 and the TFT substrate 2 is increased from the central position of the CF substrate 4 and the TFT substrate 2 toward the marginal position of the CF substrate 4 and the TFT substrate 2. In other words, the contact area between the photo spacer 6 that is located at the central position of the CF substrate 4 and the CF substrate 4 is small, while the contact area between the photo spacer 6 located at the marginal position of the CF substrate 4 and the CF substrate 4 is large.

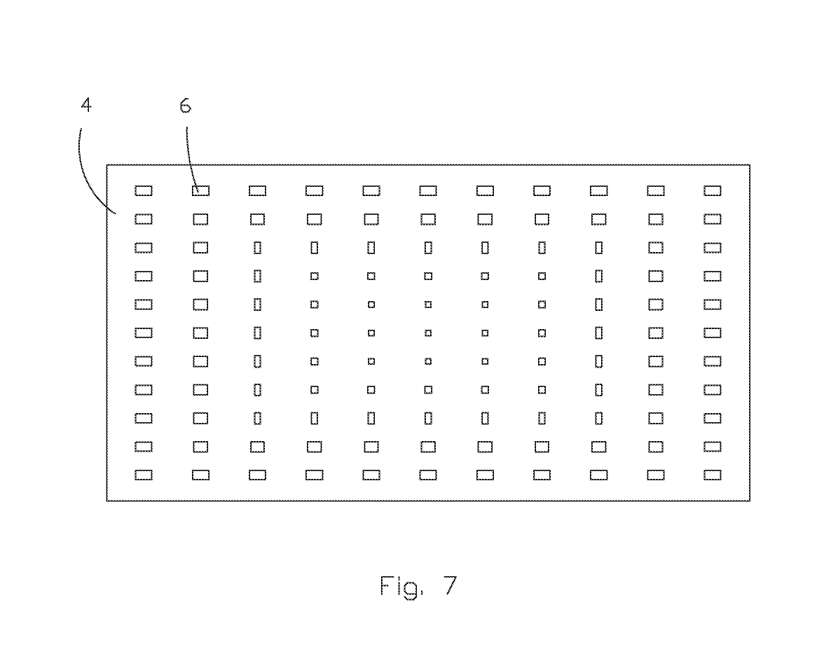

Referring to FIGS. 2 and 7, FIG. 7 is a schematic view showing shapes and distribution of the photo spacers 6 of another embodiment of liquid crystal display device according to the present invention with the photo spacers 6 being shown in contact with the CF substrate 4 to serve as an example for explanation. In the instant embodiment, the plurality of photo spacers 6 has different shapes, which include regular prisms and common quadrangular prisms. The contact area between the two opposite ends of each of the photo spacers 6 and the CF substrate 4 and the TFT substrate 2 is increased from the central position of the CF substrate 4 and the TFT substrate 2 toward the marginal position of the CF substrate 4 and the TFT substrate 2. In other words, the contact area between the photo spacer 6 that is located at the central position of the CF substrate 4 and the CF substrate 4 is small, while the contact area between the photo spacer 6 located at the marginal position of the CF substrate 4 and the CF substrate 4 is large. In other embodiments, the photo spacers 6 are a combination of alternating cylindrical photo spacers and prismatic photo spacers.

In summary, the present invention provides a liquid crystal display device, which provides the central zone and the marginal zone of the TFT substrate and the CF substrate with different bearing capabilities and deformation restoring capabilities by varying the contact areas between the photo spacers and the TFT substrate and the CF substrate. The contact areas within the marginal zone are greater and show greater bearing capabilities to support the box thickness. The contact areas within the central zone are smaller and show better deformation restoring capabilities in order to prevent the photo spacers from deformation caused by excessive frictional force, which leads to the occurrence of light leakage phenomenon. The structure is simple and the cost is low.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display device, comprising: a TFT (thin film transistor) substrate, a CF (color filter) substrate bonded to the TFT substrate in an opposing manner, a plurality of photo spacers arranged between the TFT substrate and the CF substrate, an enclosing resin frame arranged between the TFT substrate and the CF substrate, and liquid crystal received in the enclosing resin frame, wherein each of the photo spacers has two opposite ends, which are respectively in contact with the CF substrate and the TFT substrate, the contact area between the two opposite ends of a photo spacer that is located at a central position of the CF substrate and the TFT substrate and the CF substrate and the TFT substrate being smaller than the contact area between the two opposite ends of a photo spacer that is located at a marginal position of the CF substrate and the TFT substrate and the CF substrate and the TFT substrate.

2. The liquid crystal display device as claimed in claim 1, wherein the contact area between the two opposite ends of each of the photo spacers and the CF substrate and the TFT substrate is increased from the central position of the CF substrate and the TFT substrate toward the marginal position of the CF substrate and the TFT substrate.

3. The liquid crystal display device as claimed in claim 2, wherein the contact area between the two opposite ends of each of the photo spacers and the CF substrate and the TFT substrate is increased, in a linear form, from the central position of the CF substrate and the TFT substrate toward the marginal position of the CF substrate and the TFT substrate.

4. The liquid crystal display device as claimed in claim 2, wherein the contact area between the two opposite ends of each of the photo spacers and the CF substrate and the TFT substrate is increased, in a parabolic form, from the central position of the CF substrate and the TFT substrate toward the marginal position of the CF substrate and the TFT substrate.

5. The liquid crystal display device as claimed in claim 4, wherein the parabolic increase has an increase rate that starts with a high speed and then slows down or that starts with a low speed and then speeds up.

6. The liquid crystal display device as claimed in claim 1, wherein the variation of the contact area between the two opposite ends of the photo spacer and the CF substrate and the TFT substrate is realized by varying end surface areas of the two opposite ends of the photo spacer, the end surface areas of the photo spacer being varied by increasing from the central position of the CF substrate and the TFT substrate toward the marginal position of the CF substrate and the TFT substrate.

7. The liquid crystal display device as claimed in claim 1, wherein the photo spacers are uniformly distributed between the TFT substrate and the CF substrate.

8. The liquid crystal display device as claimed in claim 1, wherein the photo spacers are spheres, cylinders, elliptic cylinders, or prisms.

9. The liquid crystal display device as claimed in claim 8, wherein the prisms are triangular prisms, quadrangular prisms, or hexagonal prisms.

10. The liquid crystal display device as claimed in claim 1, wherein the photo spacers are at least two of spheres, cylinders, elliptic cylinders, and prisms.

11. A liquid crystal display device, comprising: a TFT (thin film transistor) substrate, a CF (color filter) substrate bonded to the TFT substrate in an opposing manner, a plurality of photo spacers arranged between the TFT substrate and the CF substrate, an enclosing resin frame arranged between the TFT substrate and the CF substrate, and liquid crystal received in the enclosing resin frame, wherein each of the photo spacers has two opposite ends, which are respectively in contact with the CF substrate and the TFT substrate, the contact area between the two opposite ends of a photo spacer that is located at a central position of the CF substrate and the TFT substrate and the CF substrate and the TFT substrate being smaller than the contact area between the two opposite ends of a photo spacer that is located at a marginal position of the CF substrate and the TFT substrate and the CF substrate and the TFT substrate;
wherein the contact area between the two opposite ends of each of the photo spacers and the CF substrate and the TFT substrate is increased from the central position of the CF substrate and the TFT substrate toward the marginal position of the CF substrate and the TFT substrate;
wherein the contact area between the two opposite ends of each of the photo spacers and the CF substrate and the TFT substrate is increased, in a linear form, from the central position of the CF substrate and the TFT substrate toward the marginal position of the CF substrate and the TFT substrate;
wherein the variation of the contact area between the two opposite ends of the photo spacer and the CF substrate and the TFT substrate is realized by varying end surface areas of the two opposite ends of the photo spacer, the end surface areas of the photo spacer being varied by increasing from the central position of the CF substrate and the TFT substrate toward the marginal position of the CF substrate and the TFT substrate; and
wherein the photo spacers are uniformly distributed between the TFT substrate and the CF substrate.
